(19) United States
(12) Patent Application Publication
(10) Pub. No.: US 2024/0289705 A1
(43) Pub. Date: Aug. 29, 2024

(54) System for Efficiently Providing Facilities and Professionals Resources to Streamline and Control Employment Needs

(71) Applicant: Full Med Staffing LLC, Batavia, OH (US)

(72) Inventor: Zachary Fuller, Batavia, OH (US)

(21) Appl. No.: 18/572,403

(22) PCT Filed: Jun. 29, 2022
(86) PCT No.: PCT/US2022/035494

§ 371 Date: Dec. 20, 2023

Related U.S. Application Data
(60) Provisional application No. 63/216,226, filed on Jun. 29, 2021.

(51) Int. Cl. G06Q 10/0631; H04L 67/12

(52) U.S. Cl. CPC G06Q 10/06311; H04L 67/12

(57) ABSTRACT

A computer implemented method for matching a facility with a professional at one or more work shifts is provided. The method includes receiving, at a network system including a software as a service (SaaS) platform, from a first device associated with the facility . . . a scheduling request for a specified work shift at the facility. The method further includes viewing, at the network system, from a second device associated with the professional viewing of the specified work shift. The method also includes allowing the professional to accept the specified work shift and confirming by the facility of the professional of the specified work shift.

This application claims the benefit of U.S. Provisional Patent Application No. 63/216,226 filed Jun. 29, 2021, the disclosure of which is incorporated herein by reference.

### FIELD OF THE INVENTION

This disclosure relates generally to network systems and, more particularly, to a system utilizing a software as a service (SAAS) platform that provides facilities and professionals with the tools and resources to control their respective employment needs in order to reduce risk due to short staffing issues, increase productivity by providing professional trained staff that are properly credentialed and provide a more streamlined facility where patients are not turned away due to staffing issues.

### BACKGROUND OF THE INVENTION

It is essential for facilities, such as health care facilities, hospitals, long-term care facilities, private practice, nursing homes and other any facility that uses licensed medical professionals to maintain appropriate staffing to provide a safe and efficient work environment for healthcare professionals and to provide the highest degree of quality and safe patient care. Staffing shortages can have deleterious effects on the facility's efforts to meet these goals. For example, short-staffed health care facilities may cause decreased resident satisfaction and increased risk of violations and fines for failing to meet certain safety regulations and standards. Moreover, short-staffed health care facilities may also be forced to turn away patients due to the lack of trained professionals.

These health care facilities must understand their staffing needs, such as the minimum number of staff needed to provide a safe work environment and safe patient care and adjust staffing schedules to mitigate staffing problems. Staffing issues can arise both in the short term, i.e., a professional calling in sick at the last moment or a planned absence. It is important for both the health care facilities as well as the professionals to be able to plan their schedules in both the long term, i.e., long term care staffing and short term gaps.

Facility managers often work with staffing firms and agencies to provide health care professionals for the facility's particular needs. In addition to facilities relying on staffing agencies, health care professionals often rely upon these same staffing agencies to find work. Quality health care professionals are typically in high demand and use staffing agencies to find shifts at desirable times and places to fit their preferences and lifestyle.

Although staffing agencies and firms provide certain benefits to both facilities and professionals, they suffer from certain disadvantages. For example, these staffing agencies and firms typically require expensive fees for using their services. Furthermore, there is no direct connection or access between the facilities and the professionals, i.e., the staffing agency acts as a “middle man” and, thus, the hiring process is not streamlined and is not as time efficient as possible. Another disadvantage related to the lack of direct connection or access between the facilities and the professionals is the parties do not know who they are hiring or being hired by, which prevents the parties from choosing who or where they are working, which can effect productivity and trust.

Accordingly, there is a need for an improved system or platform that circumvents staffing agencies by giving both facilities and professionals the autonomy to control employment needs both due to planned leaves or an unexpected staffing need that overcomes the disadvantages known in the art and frees up both the facilities and professionals' time to focus on the primary issue, namely, patient care and smooth operation of the heath care facility.

### SUMMARY OF THE INVENTION

In accordance with the purposes and benefits described herein, a computer implemented method for matching a facility with a professional at one or more work shifts is provided. The method includes: (1) receiving, at a network system including a software as a service (Saas) platform, from a first device associated with the facility, a scheduling request for a specified work shift at the facility; (2) viewing, at the network system, from a second device associated with the professional viewing of the specified work shift; (3) allowing the professional to accept the specified work shift; and (4) confirming by the facility of the professional of the specified work shift.

In one embodiment, the method may include a credentialing system module. The credentialing system module may utilize the network system to access the professional's credentials. The credentialing system module may utilize the network system to validate the professional's credentials. Upon validation, the credentialing system module may automatically notify the first device at the facility. The credentialing system module may allow the professional to upload documentation relating to the professional's credentials to a profile system on the network system. Upon upload, the credentialing system module may permit access to the professional's credentials to the facility.

In another embodiment, the method may include a searching module. The searching module may send a real-time notification from the facility to the professional. The real-time notification may be a shift incentive, a pay rate adjustment, or a unique facility need. The searching module may search by one or more customizable features, such as state, zip code, radius from the facility or available shifts supplied by the professional. The searching module may match one or more customizable features with another one or more customizable features.

In yet another embodiment, the method may include a scheduling system module. The scheduling system module may create a re-occurring template, wherein the re-occurring template is created on a predefined schedule. The predefined schedule may be daily, weekly or monthly. The re-occurring template may be configured to staff one or more departments within the facility. The scheduling system module may automatically send notifications to a plurality of professionals related to an incentive or unfilled shifts.

In still another embodiment, the method may include a recruitment and retention module. The recruitment and retention module may provide the professional with one or more incentives for recruiting a second professional to the system, such as a fixed fee or a percentage bonus.

In yet still another embodiment, the method may include a payment processing module. The payment processing module may include allowing the facility to directly pay the professional through a mobile application. The mobile application may be connected to a second mobile application related to the professional's checking account. The payment processing module may provide access to a payment history of the professional. The payment processing module may provide access to a recruitment benefit history of the professional.

In another embodiment, the method may include a ratings system module. The ratings system module may include a user input configured to allow the facility to enter a rating for the professional related to a performance of the professional. The ratings system module may include a display for allowing a plurality of different facilities to view the rating for the professional. The ratings system module may allow the rating to be continuously updated based upon each successive rating entered for the professional. The ratings system module may include a separate section for notes about the professional to be entered via the user input. The ratings system module may include a user input configured to allow the professional to enter a rating for the facility. The ratings system module may include a display for allowing a plurality of different professionals to view the rating for the facility. The ratings system module may allow the rating to be continuously updated based upon each successive rating entered for the facility. The ratings system module may include a separate section for notes about the facility to be entered via the user input. The ratings system module may allow the professional to view and compare one or more ratings corresponding to one or more facilities. The ratings system module may allow the facility to view and compare one or more ratings corresponding to one or more professionals.

In yet another embodiment, the method may include a comprising a messaging module. The messaging module may be configured to provide a direct communication link between the facility and the professional. The direct communication may include providing a request for additional documentation to the professional or providing access to orientation materials to the professional. The messaging module may allow interactive communication between the facility and the professional.

In accordance with another aspect of the disclosure, a method of providing scheduling services using a computing device is provided. The method includes: (1) the computing device communicating inputted information to at least one remote server; (2) based on the inputted information, accessing scheduling information from a plurality of facilities accessible to the at least one remote server; (3) generating a plurality of available shifts from the plurality of facilities; and (4) allowing a user via the computing device to accept one of the plurality of shifts from the plurality of facilities.

In one embodiment, the method includes sending a notification to one of the plurality of facilities that one of the plurality of shifts was accepted. The at least one remote server may be configured for access by a plurality of distinct users. The inputted information may include one of facility geography location, dates, and payment.

In accordance with yet another aspect of this disclosure, a non-transitory tangible machine readable medium comprising instructions configured to cause at least one processor to perform a process is provided. The medium includes: (1) receiving an input over a network from a first computing device to access one or more data points located on a remote computing device; (2) identifying one or more access credential requirements to allow the first computing device to access the remote computing device; and (3) allowing the first computing device to access the remote computing device.

In one embodiment, the remote computing device may reside in a secured data center. The remote computing device may be configured to be accessible through a firewall. The one or more access credential requirements may include user name and password. The one or more data points may include one of health care facility, scheduling openings, payment information, and rating of health care facility. The one or more data points may include one of professional name, scheduling availability, payment information, and rating of professional.

In accordance with still another aspect of this disclosure, a computer implemented method comprising instructions stored on a non-transitory computer-readable storage medium and executed on a computing device having a processor and a memory for authentication of Software as a Service (Saas) is provided. The method includes: (1) receiving a request from a first user via the computing device for accessing the SaaS from a cloud server; (2) verifying one or more access credential requirements associated with the first user; (3) upon verification, providing the first user access to the SaaS from the cloud server; (4) allowing the first user to manipulate the SaaS; and (5) storing the manipulations made by the first user to the Saas in the cloud server.

In accordance with yet another aspect of this disclosure, a scheduling system for filling working shifts at a health care facility is provided. The scheduling system includes: (1) a memory; (2) one or more processors associated with the memory; (3) a scheduling component executable by the one or more processors configured to generate a plurality of available shifts to be filed, wherein each of the plurality of shifts has at least one specified parameter associated therewith; and (4) a user input allowing a plurality of different users to access the scheduling component and select one of the plurality of available shifts.

In one embodiment, the at least one specified parameter may include experience required, expertise required, health care facility information, or payment information.

In accordance with still another aspect of this disclosure, a credentialing system for health care professionals is provided. The credentialing system includes: (1) a memory; (2) one or more processors associated with the memory; (3) a credentialing component executable by the one or more processors configured to allow the health care professional input one or more credentials; and (4) a validation component to allow a health care facility to confirm the one or more credentials inputted by the health care professional.

In accordance with yet another aspect of this disclosure, a searching system is provided. The searching system includes: (1) a memory; (2) one or more processors associated with the memory; and (3) a searching component executable by the one or more processors configured to generate a real-time notification from a health care facility to one or more health care professionals.

In accordance with still another aspect of this disclosure, a recruitment and retention system is provided. The recruitment and retention system includes: (1) a memory; (2) one or more processors associated with the memory; and (3) a recruiting component executable by the one or more processors configured to generate a plurality of incentives for a health care professional to earn for meeting a predetermined factor.

In one embodiment, the predetermined factor may include a percentage bonus for recommending a second health care professional to a health care facility.

In accordance with yet another aspect of this disclosure, a payment system is provided. The payment system includes a memory, one or more processors associated with the memory, and a payment processing component executable by the one or more processors configured to allow direct payment from a health care facility to a health care professional.

In accordance with still another aspect of this disclosure, a ratings system is provided. The ratings system includes a memory, one or more processors associated with the memory, and a rating component executable by the one or more processors configured to allow a health care provider to enter rating information about a health care facility.

In accordance with yet another aspect of this disclosure, a ratings system is provided. The ratings system includes a memory, one or more processors associated with the memory, and a rating component executable by the one or more processors configured to allow a health care facility to enter rating information about a health care provider.

In accordance with still another aspect of this disclosure, a messaging system is provided. The messaging system includes a memory, one or more processors associated with the memory, and a messaging component executable by the one or more processors configured to allow a health care provider and a health care facility to have a direct communication link via a secured system.

### BRIEF DESCRIPTION OF THE DRAWING FIGURES

The accompanying drawing figures incorporated herein and forming a part of the specification, illustrate several aspects of the invention and together with the description serve to explain certain principles thereof. In the drawing figures:

FIG. 1 is a flowchart of a system for matching a facility with a professional at one or more work shifts forming one aspect of this disclosure;

FIG. 2 is an example block diagram showing a system forming one aspect of this disclosure; and

FIG. 3 is an example block diagram showing a scheduling system forming one aspect of this disclosure.

### DETAILED DESCRIPTION

In the following detailed description, reference is made to the accompanying drawings and photographs that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, an improved system or platform that provides both facilities and professionals with the autonomy to take the reins of all aspects of their employment needs is hereinafter described.

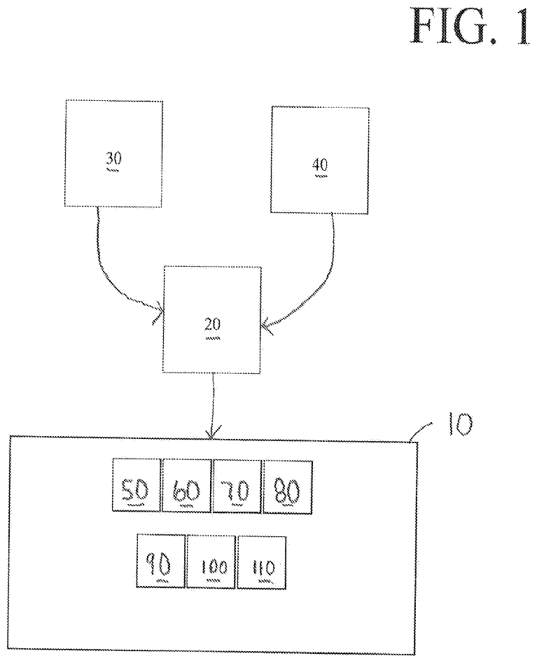

Reference is now made to FIGS. 1-3, which illustrate a system environment such as a network system 10 that allows both facilities and professionals to control their employment needs. As perhaps best illustrated in FIG. 1, the system may be provided as a software as a service (Saas) platform 20 that circumvents the need for staffing agencies and firms. In a SaaS model, software is deployed over the Internet and/or is deployed to run behind a firewall on a local area network or personal computer. With SaaS, a provider licenses an application to customers either as a service on demand, through a subscription, a “pay-as-you-go” model or at no charge. This approach to application delivery is part of the utility computing model where all the technology are hosted on a “cloud”, managed by a service provider and accessed over the Internet as a service.

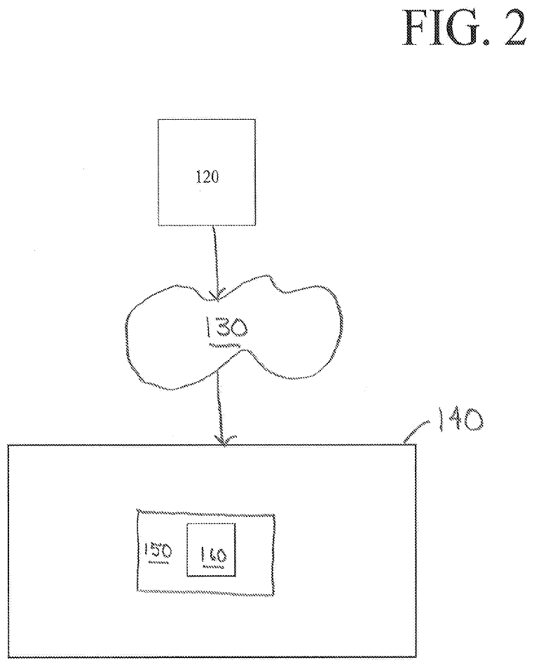

With respect to FIG. 2, a computing device 120 allows information to be inputted by a user to at least one remote server 150. It should be appreciated that the remote server may be accessed by multiple users. Based upon the inputted information including but not limited to geographic location of facility or user, dates and payment information, the user may access data points 160 (such as in the form of scheduling information) from a plurality of different health care facilities located within the remote server 150. Furthermore, based upon the inputted information, a plurality of available shifts may be generated and the user may accept one or more of the plurality of shifts. The computing device 120 and the remote server are connected via a network. 130, such as a cloud-based network. The remote server 150 may be positioned behind a firewall 140 or other secured data center. A notification may be generated and sent to the facility when a user accepts a shift.

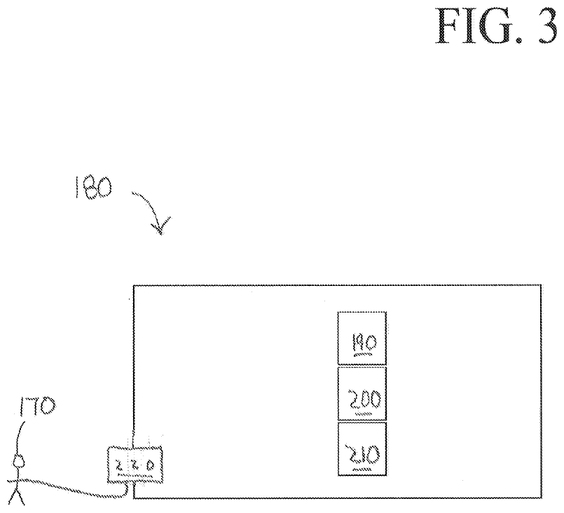

Turning to FIG. 3, a user 170 may access a system 180 via a user input 220. The system 180 includes a memory 190, one or more processors 200 and an additional component 210. The additional component may be one of a scheduling component, a credentialing component, a validation component, a searching component, a recruiting component, a payment processing component, a rating component, and a messaging component.

As discussed above, the system 10 may be utilized by health care facilities, including but not limited to hospitals, long-term care facilities, private practice, nursing homes and other any facility that uses a licensed medical professional. Of course, it should be appreciated that markets other than health care may utilize the system, such as veterinarian clinics, schools and substitute teachers, dentist offices, commercial maintenance and cleaning as well as any industries that utilize independent contractors and part-time employees. In addition, professionals, such as health care professionals (registered nurses (RN's), licensed practical nurses (LPN's), certified nursing assistants (CNA's)) may access the system 10.

Turning back to FIG. 1, the facility as well as the professional may access the system 10 via a device 30, 40, such as a computer, mobile computer, cellular device via a mobile application. The system 10 includes a plurality of different modules for both the facility and the professional to view. These modules include: a credentialing system module 50; a searching module 60; a scheduling system module 70; a recruitment and retention module 80; a payment processing module 90; a rating system module 100; and a messaging module 110. Each of these modules will be described in more detail below.

The credentialing system module 50 is designed to save time, reduce expenses and streamline verifications. For the facility, the credentialing system module 50 avoids time on-boarding a new employee as credentials are validated by the system, not the facility. The credentialing system module 50 also saves the facility on the cost of credentialing as it is covered by the system. Finally, the credentialing system module 50 allows for easy access to an individual's (professional's) credentials from a single platform. Turning to the professional, the credentialing system module 50 uploads required documentation to their profile and permits access to any qualified facility. Furthermore, the credentialing system module 50 provides for instant notification when credentials are validated. Finally, the credentialing system module 50 shares their credential from a single platform.

With respect to the search module 60, it easily identifies the needs for the facility and the benefits for the professional. The search module 60 sends out real-time notifications from the facility for shift incentives, pay rate adjustments and unique facility needs. For the professional, the search module searches by state, zip code or radius to find facilities and shifts that match the approved credentials provided by the professional.

Turning to the scheduling system module 70, it is designed to simply staffing needs, efficiently filling last minute coverage needs and improves continuity. For the facility, the scheduling system module 70 creates a re-occurring template (on a predefined schedule, i.e., daily, weekly or monthly) for staffing across multiple departments. The scheduling system module 70 further sends notifications out to potential professionals with incentive to fill gaps as they arise. The scheduling system module 70 also provides notifications to the facility on shifts that are not being filled. For the professional, the scheduling system module 70: (1) organizes daily/weekly/monthly schedules in one place; (2) allows professionals to grab a last minute shift that fits their needs; and (3) creates a routine for the professional and their family.

With respect to the recruitment and retention module 80, it is designed to reduce traditional industry problems of abandonment, poaching and lack of loyalty between professional and facility. For the facility, the recruitment and retention module 80 is designed to allow it to retain quality employees. For the professional, the recruitment and retention module 80 provides the professional with ability to recruit other professionals and earn a percentage bonus of the total hours that the recruited professional works.

Turning to the payment processing module 90, it is designed to save a considerable amount of money by paying professionals directly from the facility (not a staffing agency) and tracking flow of funds. In order to do so, it utilizes service feeds to eliminate staffing agencies. For the facility, the payment processing module 90 allows the facility to directly pay the professional through a mobile application. Instead of the high fees typically charged by staffing agencies, the payment processing module 90 allows contracted professionals to be paid for a small service fee rather than the inflated agency pricing. An advantage of the payment processing module 90 is a single platform is utilized to order, approve and pay professionals. For the professionals, they receive funds directly from a mobile application after shift validation is complete. Typically, a professional will earn more independently by working directly with the facilities and controlling their own schedule. Finally, a professional may easily view their payment history and recruitment benefits.

With respect to the rating system module 100, it is designed to enhance trust between the facilities and the professionals, improves productivity of the professionals and provides a quality/control measure for evaluating potential professionals. Specifically, for the professionals, the rating system module 100 allows the facility to view a professional's rating and their performance at other facilities. It further allows the facility to provide a star rating and optional commentary on the professional at the conclusion of the shift. Advantageously, the rating system module 100 allows the facility to select reputable professionals to maintain a good reputation within the organization. For the professional, the rating system module 100 allows the professional to view a facility's rating and the experiences of other professionals at the facility. Similar to allowing the facility to provide a star rating and optional commentary on the professional at the conclusion of the shift, the professional has the option to provide a star rating and optional commentary on the facility at the conclusion of their shift. Finally, the rating system module 100 allows professionals to choose to work at facilities that meet their career expectations and needs.

Turning to the messaging module 110, it is designed to simply communication barriers, send attachments or addendums between facilities and professionals and saves orientation time. For the facilities, the messaging module 110 provides facilities with direct communication capabilities with professionals once a shift is covered. The message module 110 allows facilities to reach out to professionals to request additional documentation and pushes orientation materials to first time contractors. For the professionals, the messaging module 110 provides professionals with direct communication capabilities with facilities once a shift is covered. It saves times by allowing messaging requirements to be sent directly to the facility. It further prepares professionals for a facility's requirements.

The system described herein offers a number of advantages such as establishing a direct connection or access from facilities to validated and qualified professionals. The system further efficiently streamlines employment procedures, such as staffing, scheduling, performance ratings, credentialing and payment processes into a single system such that time is freed up for the facility to enhance the success of their organization. The system also consolidates recruiting and marketing efforts into a single system. The system further eliminates any dependency on staffing agencies, which makes the hiring process less expensive and more efficient. In addition to the advantages provided to facilities, professionals are provided with the flexibility to choose their work schedules and locations.

Users attempting to access the remote server must have certain requirements, such as user name and password and the system is configured to identify and/or verify these requirements in order to allow access to the remote server or computing device.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

1.-71. (canceled)

72. A computer implemented method for matching a facility with a professional at one or more work shifts, comprising:
receiving, at a network system including a software as a service (SaaS) platform, from a first device associated with the facility, a scheduling request for a specified work shift at the facility;
viewing, at the network system, from a second device associated with the professional viewing of the specified work shift;
allowing the professional to accept the specified work shift; and
confirming by the facility of the professional of the specified work shift.

73. The method of claim 72, further comprising a credentialing system module.

74. The method of claim 73, wherein the credentialing system module utilizes the network system to access and validate the professional's credentials.

75. The method of claim 72, further comprising a searching module.

76. The method of claim 75, wherein the searching module searches by one or more customizable features.

77. The method of claim 72, further comprising a scheduling system module.

78. The method of claim 77, wherein the scheduling system module creates a re-occurring template.

79. The method of claim 72, further comprising a recruitment and retention module.

80. The method of claim 79, wherein the recruitment and retention module provides the professional with one or more incentives for recruiting a second professional to the system.

81. The method of claim 72, further comprising a payment processing module configured to allow the facility to directly pay the professional through a mobile application.

82. The method of claim 72, further comprising a ratings system module.

83. The method of claim 82, wherein the ratings system module includes a user input configured to allow the facility to enter a rating for the professional related to a performance of the professional.

84. The method of claim 72, further comprising a messaging module.

85. The method of claim 84, wherein the messaging module is configured to provide a direct communication link between the facility and the professional.

86. A method of providing scheduling services using a computing device, comprising:
the computing device communicating inputted information to at least one remote server;
based on the inputted information, accessing scheduling information from a plurality of facilities accessible to the at least one remote server;
generating a plurality of available shifts from the plurality of facilities; and
allowing a user via the computing device to accept one of the plurality of shifts from the plurality of facilities.

87. The method of claim 86, further comprising sending a notification to one of the plurality of facilities that one of the plurality of shifts was accepted.

88. The method of claim 86, wherein the at least one remote server is configured for access by a plurality of distinct users.

89. The method of claim 86, wherein the inputted information includes one of facility geography location, dates, and payment.

90. A scheduling system for filling working shifts at a health care facility, comprising:
a memory;
one or more processors associated with the memory;
a scheduling component executable by the one or more processors configured to generate a plurality of available shifts to be filed, wherein each of the plurality of shifts has at least one specified parameter associated therewith;
a user input allowing a plurality of different users to access the scheduling component and select one of the plurality of available shifts.

91. The scheduling system according to claim 90, wherein the at least one specified parameter includes experience required, expertise required, health care facility information, or payment information.
